(19) United States
(12) Patent Application Publication
(10) Pub. No.: US 2024/0418901 A1
(43) Pub. Date: Dec. 19, 2024

(54) STATIC OR QUASI-STATIC MULTI-VIEW OR 3D INSPECTION OF CARGO

(71) Applicant: Smiths Detection France S.A.S., Vitry Sur Seine (FR)

(72) Inventor: Serge MAITREJEAN, Vitry-sur-Seine (FR)

(21) Appl. No.: 18/705,320

(22) PCT Filed: Oct. 25, 2022
(86) PCT No.: PCT/EP2022/079736

§ 371 Date: Apr. 26, 2024

(30) Foreign Application Priority Data
Oct. 27, 2021 (GB) 2115458.8

(51) Int. Cl. G01V 5/226

(52) U.S. Cl. CPC G01V 5/226

(57) ABSTRACT

An apparatus configured to inspect cargo is provided. The cargo and the apparatus have a mutual scan movement substantially along a scan direction. The apparatus includes at least one source configured to generate a plurality of points of irradiation configured to at least partially surround the cargo in a plane substantially perpendicular to the scan direction, and a plurality of detectors configured to at least partially surround the cargo in at least one detection plane substantially perpendicular to the scan direction, and to detect the penetrating radiation after transmission through the cargo, wherein each point of irradiation is configured to emit a fan of penetrating radiation towards the cargo in a general direction of emission different from other points of irradiation in the plurality of points of irradiation.

### CROSS-REFERENCE TO RELATED APPLICATIONS

This application is a national stage application of PCT/EP2022/079736, filed on Oct. 25, 2022, which claims priority to GB Application 2115458.8, filed on Oct. 27, 2021, both of which are incorporated herein by reference in their entirety.

### BACKGROUND

The disclosure relates but is not limited to an apparatus configured to inspect cargo, the cargo and the apparatus having a mutual scan movement substantially along a scan direction during inspection. The disclosure also relates to a corresponding method and corresponding computer programs or computer program products.

For providing volumetric information of cargo, some inspection devices include a penetrating radiation source and a detection line mounted face-to-face on an assembly, the assembly being configured to rotate around cargo to inspect (such as a truck and its containers).

In such devices, the assembly is large and heavy (between 5 and 10 tonnes), which prevents the assembly from attaining fast rotation speed. Acquisition of inspection data is therefore slow.

### BRIEF DESCRIPTION

Aspects and embodiments of the invention are set out in the appended claims. These and other aspects and embodiments of the disclosure are also described herein.

Embodiments of the present disclosure provide a new apparatus configured to inspect cargo. Embodiments provide an apparatus including a plurality of radiation emission zones of penetrating radiation, surrounding the cargo to inspect, without moving parts or with a reduced number of moving parts. Embodiments provide an apparatus including a plurality of detectors of penetrating radiation, surrounding the cargo to inspect, without moving parts. Even if the plurality of radiation emission zones of penetrating radiation and/or the plurality of detectors may be cumbersome and/or heavy, embodiments may provide a static or quasi static assembly including radiation emission zones and detectors for acquisition of inspection data. Embodiments are configured to output image data for generating one or more images of the cargo based on the penetrating radiation detected by the detectors. Embodiments may be used for fast computed tomographic inspection.

Assemblies of embodiments may be less prone to mechanical failure than rotating assemblies. Assemblies of embodiments may be properly shielded, and thus may be less irradiating, than rotating assemblies.

### BRIEF DESCRIPTION OF DRAWINGS

Embodiments of the disclosure will now be described in detail, by way of example only, with reference to the accompanying drawings, in which:

FIG. 1 schematically illustrates an example apparatus according to the disclosure, in a (YOZ) plane;

FIG. 2 schematically illustrates an example apparatus according to the disclosure, in a (YOZ) plane;

FIG. 3 schematically illustrates an example plurality of detectors according to the disclosure, in a (YOZ) plane;

FIG. 4A schematically illustrates an example apparatus according to the disclosure, in a (XOZ) plane;

FIG. 4B schematically illustrates an example apparatus according to the disclosure, in a (XOZ) plane;

FIG. 5 schematically illustrates an example apparatus according to the disclosure, in a (YOZ) plane;

FIG. 6A schematically illustrates an example apparatus according to the disclosure, in a (XOZ) plane;

FIG. 6B schematically illustrates an example apparatus according to the disclosure, in a (XOZ) plane;

FIG. 7 schematically illustrates an example apparatus according to the disclosure, in a (YOZ) plane;

FIG. 8 schematically illustrates an example apparatus according to the disclosure, in a (YOZ) plane;

FIG. 9 schematically illustrates an example plurality of detectors according to the disclosure, in a (YOZ) plane;

FIG. 10 schematically illustrates an example apparatus according to the disclosure, in a (YOZ) plane; and

FIG. 11 schematically illustrates an example method according to the disclosure.

In the drawings like reference numerals are used to indicate like elements.

### DETAILED DESCRIPTION

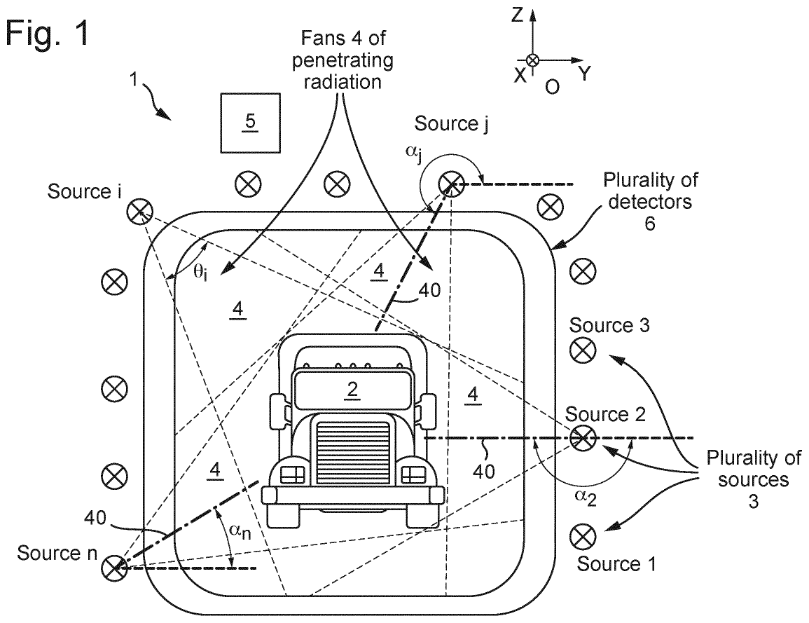

In an aspect of the present disclosure and as illustrated in FIG. 1, it is disclosed an apparatus 1 configured to inspect cargo 2. The cargo 2 and the apparatus 1 have a mutual scan movement substantially along a scan direction during inspection, e.g. scan direction (OX).

The apparatus 1 includes at least one source 3 of penetrating radiation. As explained in greater detail below, the apparatus is configured to generate, using the at least one source, a plurality n of radiation emission zones 3 configured to at least partially surround the cargo 2 in a plane substantially perpendicular to the scan direction, e.g. a plane parallel to plane (YOZ), substantially perpendicular to the scan direction (OX). As explained in greater detail below, the apparatus may be configured to generate the plurality n of radiation emission zones 3 by including a plurality of sources 3 and/or by moving the at least one source 3. In FIG. 1 as a non-limiting example, each source 3 materializes only one radiation emission zone.

The plurality n of radiation emission zones 3 are configured to selectively and alternately generate penetrating radiation (such as X-rays, but other types of radiation may be envisaged). In other words, not two radiation emission zones generate penetrating radiation simultaneously. The plurality n of radiation emission zones includes at least three radiation emission zones 3. In some examples, the plurality of radiation emission zones includes n radiation emission zones, such that 3<n≤1000. Other numbers n may be envisaged such that 5≤n≤100, or 10≤n≤50, such as n=15 or n=30 as non-limiting examples. Each radiation emission zone 3 in the plurality n of radiation emission zones is configured to emit a fan 4 of penetrating radiation towards the cargo 2 in a general direction 40 of emission different from other radiation emission zones 3 in the plurality of radiation emission zones. In FIG. 1, the general direction 40 is defined by an axis originating in the radiation emission zone towards the cargo and being median to the fan 4, i.e. median to all the rays forming the fan 4. Each axis has an angle α e.g. with respect to the (OY) direction, such as angles α₂, αⱼ and αₙ illustrated in FIG. 1.

The radiation emission zones 3 are configured to selectively and alternately generate the penetrating radiation 4 once and only once during a mutual scan displacement corresponding substantially to a dimension of the plurality of detectors in the scan direction (OX). In other words, only one radiation emission zones 3 in the plurality n is generating penetrating radiation at any given time. The selective generation by the radiation emission zones 3 follows a selection sequence. In some examples, the selection sequence includes at least one of a random sequence, a regular sequence or a geometrical successive sequence. The geometrical successive sequence may follow the geometrical order of the radiation emission zones in the plurality n of radiation emission zones, e.g. in an increasing order or decreasing order. For example, the first and only radiation emission zone 3 to emit penetrating radiation 4 in the sequence may be the first radiation emission zone 3 in the plurality n, followed by the second radiation emission zone 3 in the plurality n being the only radiation emission zone emitting the radiation 4, etc. successively until the last radiation emission zone 3 in the plurality n. Alternatively or additionally, the regular sequence may follow a function f(i), such that 1≤i≤n, f being a one-to-one pre-determined function (i.e. a bijection) determining the radiation emission zone for generation of the penetrating radiation 4 in the sequence, from the set {1,2, . . . n} to itself. In some examples f does not depend on the X-coordinate (i.e. mutual position of the cargo and the apparatus) along the scan direction (OX). Alternatively, the function f(i,x) can change with the X-coordinate. In some examples, the radiation emission zone 3 for generation of the penetrating radiation 4 in the sequence can be selected at random, provided that all the radiation emission zones are emitting a fan 4 once and only once during the mutual scan displacement corresponding approximately to the dimension of the detectors in the scan direction (OX).

As illustrated in FIG. 1, the apparatus may include a selector 5 configured to control the radiation emission zone 3 of the plurality n of radiation emission zones based on the selection sequence.

The apparatus 1 further includes a plurality of detectors 6 configured to at least partially surround the cargo 2 in at least one detection plane substantially perpendicular to the scan direction, e.g. at least one detection plane parallel to plane (YOZ), substantially perpendicular to the scan direction (OX). The plurality of detectors 6 are configured to detect the penetrating radiation 4 after transmission through the cargo 2.

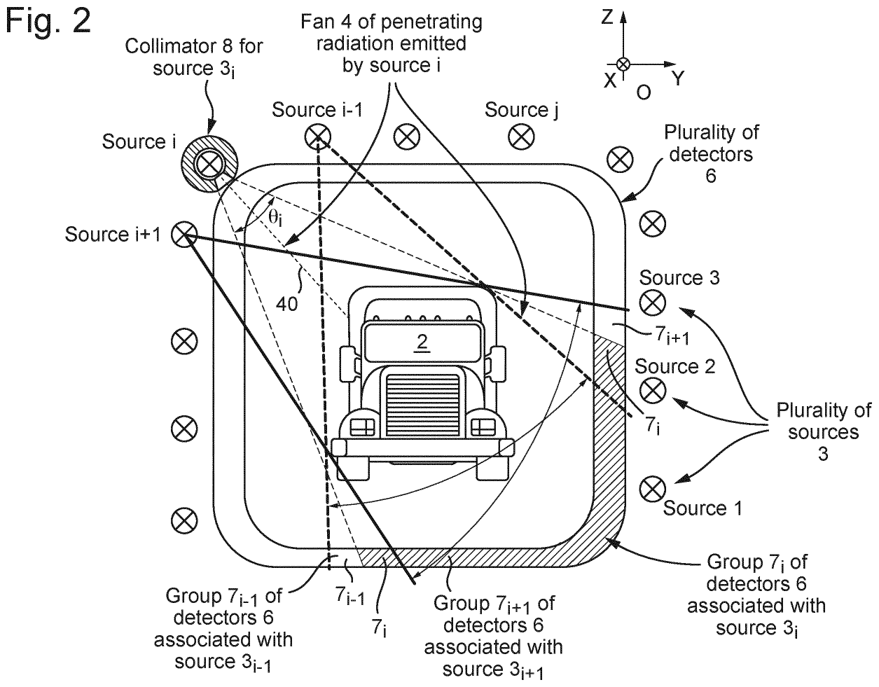

As illustrated in FIG. 2, each radiation emission zone 3 is associated with a group 7 of the plurality of detectors 6 corresponding to the fan 4 of penetrating radiation emitted by the radiation emission zone 3, e.g. the group 7 is associated with radiation emission zone i in FIG. 2.

As illustrated in FIG. 2, two respective groups 7 of the plurality of detectors associated with two respective adjacent radiation emission zones 3 selectively generating penetrating radiation in the plurality of radiation emission zones 3 are configured to share at least two detectors so that the two respective groups partly overlap each other. In other words, at least two (and in practice many) detectors 6 are common to two respective, successive groups 7. This means that the respective groups of detectors do not need to be totally exclusive and physically located in totally separate planes for two different, e.g. adjacent, radiation emission zones.

In FIG. 2, it is apparent that the two respective groups 7ᵢ₋₁ and 7ᵢ associated with the two respective adjacent radiation emission zones 3ᵢ₋₁ and 3ᵢ share a great part of the detectors, i.e. many of the detectors of the groups are in common to the groups, such that the two groups 7ᵢ₋₁ and 7ᵢ partly overlap each other. Some of the detectors 6 at the sides of the groups 7ⁱ⁻¹ and 7ᵢ are not in common because, as already stated, each radiation emission zone in the plurality of radiation emission zones is configured to emit a fan of penetrating radiation towards the cargo in a general direction of emission different from other radiation emission zones in the plurality of radiation emission zones.

Similarly, the two respective groups 7ᵢ and 7ᵢ₊₁ associated with the two respective adjacent radiation emission zone 3ᵢ and 3ᵢ₊₁ partly overlap each other.

In some examples, each group 7 of the plurality of detectors 6 is configured to be associated with the radiation emission zones 3 configured to emit the corresponding fan 4 of penetrating radiation by absence of readings of detection of penetrating radiation by detectors 6 which are not part of the corresponding group 7. In other words, the apparatus may simply not read the measures from the detectors 6 which are not part of the corresponding group 7. In some examples the selector 5 may be configured to control the readings based on the groups, for example based on the selection sequence described above. The absence of readings from the detectors 6 which are not part of the corresponding group 7 prevents or minimizes artifacts in the inspection images due, for example, to scattering. Additionally or alternatively, readings of the detectors which are not part of the group may be taken into account, for monitoring the beam of penetrating radiation, i.e. for measuring dose fluctuations between pulses of the same radiation emission zone. It should be understood that, if the angle of collimators (the collimators are explained in more detail later) is adjusted such as covering just the cargo, this cannot be achieved. However, if the angle of the collimators covers more than the cargo (and the corresponding group of detectors is chosen such as the angle covers substantially more than the cargo), reading of the signals of the detectors in the group receiving radiation flux which is not transmitted through the cargo can also be used for monitoring the beam (e.g., for correcting the image data from beam fluctuation).

The plurality of detectors 6 are static with respect to the cargo 2 in a plane substantially perpendicular to the scan direction (OX). The detectors 6 do not include moving parts, such as rotating parts, in a plane substantially perpendicular to the scan direction (OX). In some examples, at least some of the plurality of detectors are configured to form a continuous array of detectors all around the cargo in a single plane substantially perpendicular to the scan direction.

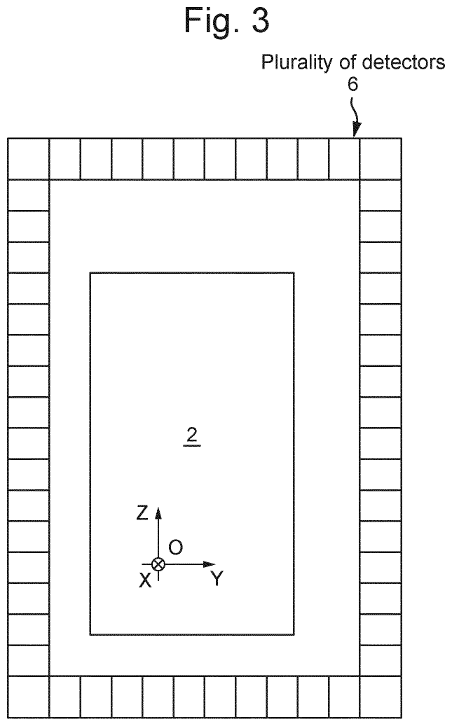

In some examples, the plurality of detectors 6 is configured to completely surround the cargo 2 in at least one, single, detection plane substantially perpendicular to the scan direction (OX). As illustrated in FIGS. 1 and 2, the plurality of detectors 6 are configured to form a continuous array of detectors all around the cargo 2. As illustrated in FIGS. 1 and 2, in some examples, the continuous array of detectors 6 may be of substantially square shape in a plane substantially perpendicular to the scan direction (OX). As illustrated in FIG. 3, in some examples, the continuous array of detectors 6 may be of substantially rectangular shape in a plane substantially perpendicular to the scan direction. As illustrated in FIG. 2, each source 3 includes a collimator 8 configured to collimate the fan 4 around the general direction 40 of emission (only one collimator is illustrated in FIG. 2).

As illustrated in FIG. 2, the collimator 8 may be configured to collimate the fan 4 around the general direction of emission in a plane substantially parallel to the (YOZ) plane, such as the angle θᵢ just covers the cargo 2 in the (YOZ) plane. This collimation reduces the radiation safety area of the apparatus 1.

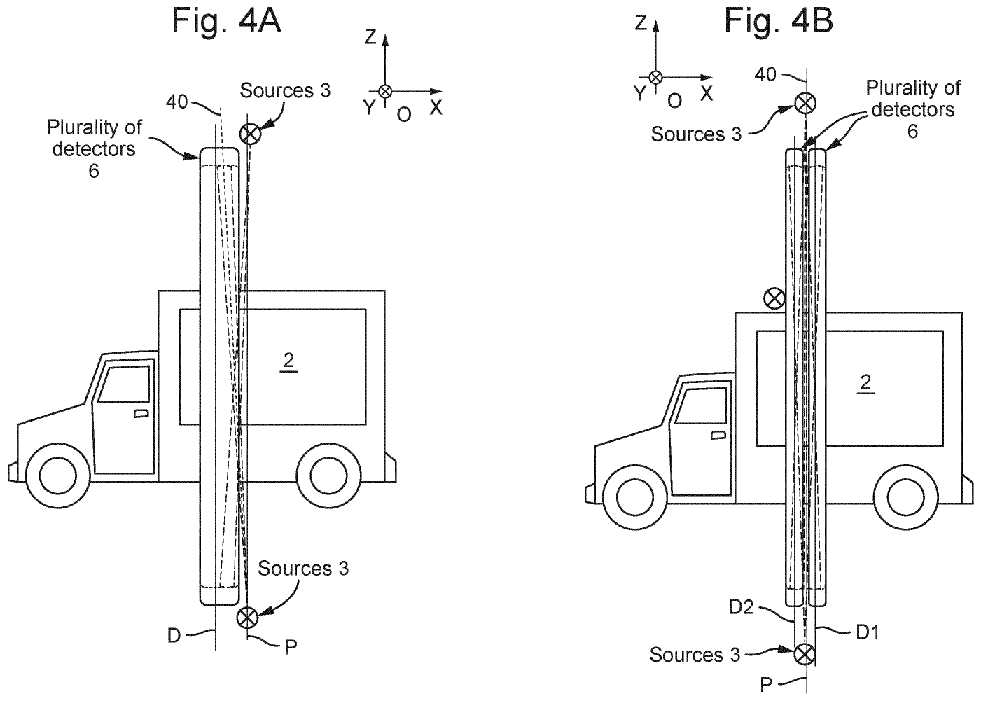

As illustrated in FIGS. 4A and 4B, the collimator 8 may be configured to collimate the fan 4 around the general direction 40 of emission in a plane substantially parallel to the (XOZ) plane, such as the fan just covers the plurality of detectors 6 in the scan direction (OX), in order to reduce the radiation safety area of the apparatus.

In some examples, the at least one source 3 may be configured to be static with respect to the cargo in a plane substantially perpendicular to the scan direction. In some examples, the apparatus including a plurality of radiation emission zones, at least two radiation emission zones are configured to be located with respect to the cargo in a single plane substantially perpendicular to the scan direction.

Alternatively or additionally, the at least one source 3 may be configured to move with respect to the cargo in a plane substantially perpendicular to the scan direction. In some examples, the apparatus including a plurality of radiation emission zones, at least two radiation emission zones are configured to move with respect to the cargo in a single plane substantially perpendicular to the scan direction.

As illustrated in FIG. 4A, the radiation emission zones 3 may be located sideways in at least one plane P different from the at least one detection plane D where the plurality of detectors 6 are located. Both planes P and D are substantially parallel to plane (YOZ). In FIG. 4A, all the radiation emission zones 3 are located in the plane P, but in some examples (not shown in the figures) at least some sources (and corresponding radiation emission zones) may be located in another plane, e.g. symmetrical to plane P with respect to plane D. In such examples, the total number of radiation emission zones may be distributed between the two symmetrical planes, e.g. equally distributed and each plane having n/2 radiation emission zones. As illustrated in FIG. 4A, the general direction of emission of each radiation emission zone is tilted with respect to the at least one detection plane D to reach the group of detectors 6 associated with the radiation emission zone 3. As illustrated in FIG. 4B, the plurality of detectors 6 may be located in two detection planes D1 and D2, and the plurality of radiation emission zones 3 may be located in a plane P located between the two detection planes D1 and D2. As illustrated in FIG. 4B, the general direction 40 of emission of each radiation emission zone 3 may be parallel to the two detection planes D1 and D2 so as to reach the group of detectors 6 associated with each respective radiation emission zone 3. In the example of FIG. 4B, the apparatus is symmetrical in the (OX) direction and may provide a better configuration for inspection image reconstruction, for example compared to the embodiment of FIG. 4A.

In operation, for each emission of a fan 4, the associated group 7 of detectors 6 measures the flux of penetrating radiation transmitted through the cargo. Once all of the radiation emission zones in the plurality have emitted a fan 4, the apparatus is configured to output image data corresponding to a set of image data numbered from 1 to n. The output image data may be used for generating one or more images of the cargo based on the penetrating radiation detected by each group of detectors, such as multiple 2D inspection images of the cargo.

Alternatively or additionally to the stated generation of 2D inspection images, the apparatus may be configured to process the image data so that the image data contains volumetric information about the cargo. In some embodiments, the output image data may be configured to be used for computed tomography of the cargo, and the measurements of the plurality of detectors are points of view which may be used as inputs of a tomographic reconstruction.

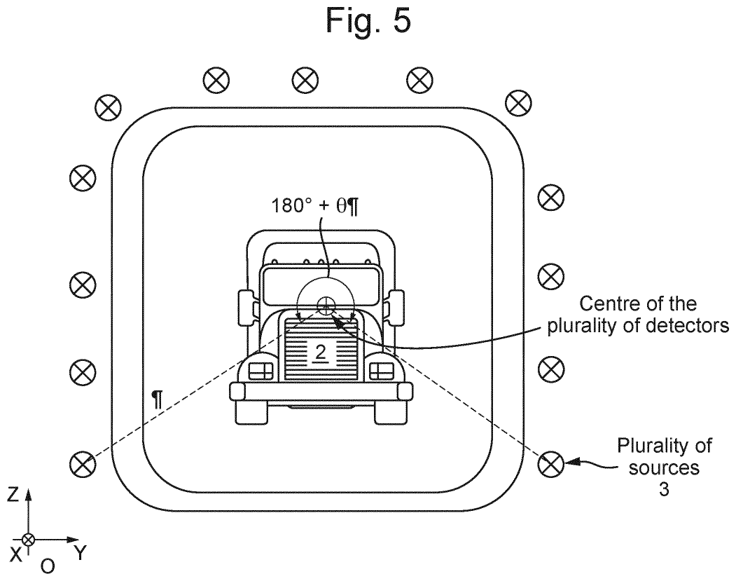

As illustrated in FIG. 5, it is not necessary to have the plurality of radiation emission zone 3 completely surroundings the cargo 2. It is a well-known fact in tomographic reconstruction that the plurality of radiation emission zones may be configured to surround the cargo 2 by forming an angle Θ such that:

$$Θ \geq 180 ° + {max}_{{S}_{i}} ( θi ) .$$

wherein each radiation emission zone Sᵢ in the plurality n of radiation emission zones, such that 1≤i≤n, is configured to emit the fan of penetrating radiation with an angle θᵢ.

The more radiation emission zones the better for tomographic reconstruction, such as 1000 or 100 radiation emission zones. However, tomographic reconstruction may still be performed with n being such as 15≤n≤30. Other numbers n may be envisaged such that 30≤n≤50, as a non-limiting example.

An apparatus including a plurality n such that 3<n≤10 may be used to provide multiple high-resolution images of the same cargo. The multiple high-resolution images may provide instrumental information on the content and/or may be used by an automated threat detection software. The output data may be used in at least one of several types of reconstruction algorithms, such as filtered back projections algorithms, algebraic reconstruction techniques, reconstruction by regularization with prior knowledge as non-limiting examples.

As illustrated in e.g. FIG. 3, in some examples each detector 6 may include a single detector element, the detector element including a scintillator, a photosensor like a photodiode and an associated electronic channel.

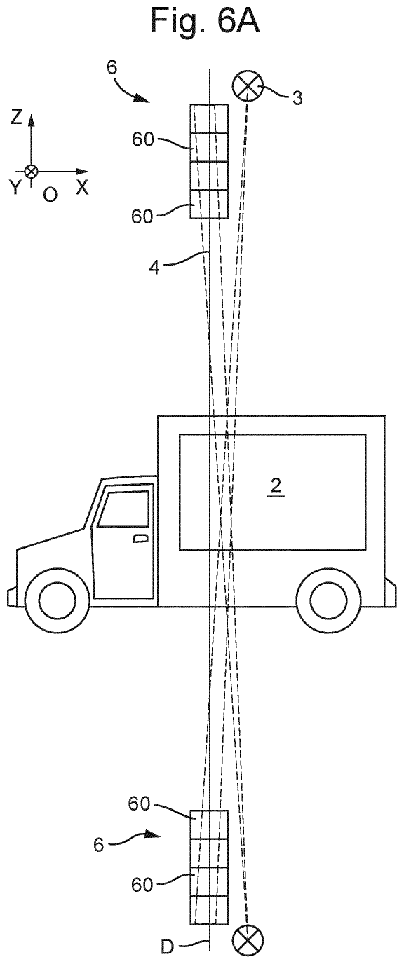

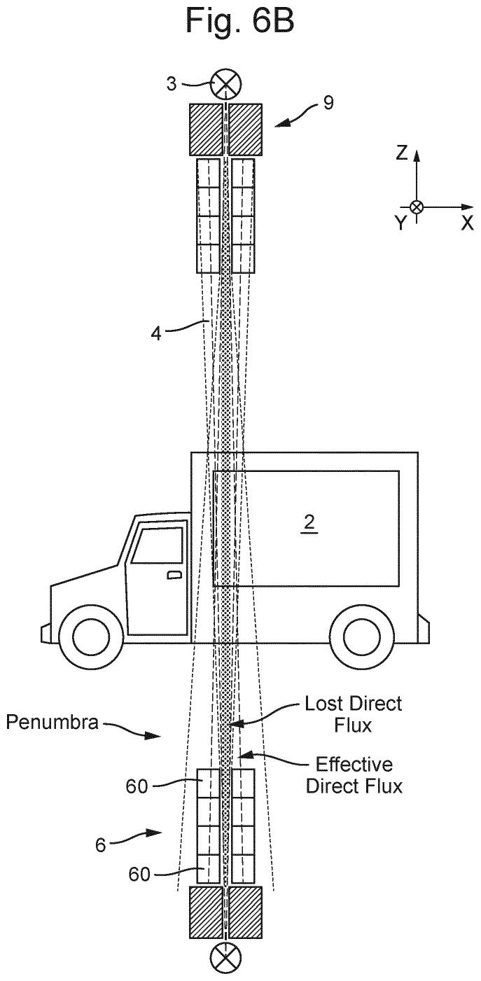

As illustrated in FIGS. 6A and 6B, in some examples, each detector 6 may including a plurality of stacked detector elements 60 in a plane D substantially perpendicular to the scan direction (OX), each of the detector elements including a scintillator, a photosensor like a photodiode and an associated electronic channel. In such cases, the apparatus may be configured to determine a flux of the penetrating radiation incident on each detector of a group, based on signal data obtained for each detector element in the group, as described in GB2013016.7 incorporated herein by reference.

In brief, in order to determine the flux of the penetrating radiation incident on each detector of a group, based on signal data obtained for each detector element in the group, the plurality of detectors 6 of the disclosure form a two-dimensional array of detector elements surrounding the cargo in longitudinal directions of the array (e.g. in the YOZ plane), each detector forming a row of the array along a longitudinal direction of the array, and each detector elements being arranged in columns in a depth direction perpendicular to the longitudinal direction of the array surrounding the cargo. An example method for determining the flux of inspection radiation includes obtaining signal data associated with each detector element of the array and determining the flux of the inspection radiation incident on each row of the array corresponding to a detector 6, based on the obtained signal data. The determined flux enables generating an inspection image, without the need for the detectors to be focused towards the center of the radiation emission zones 3. The detectors may thus be referred to as self-aligning in the present disclosure. Reciprocally, it should be understood that the position of the radiation emission zones with respect to the array of detector elements is not critical for generating the inspection image, and the radiation emission zones may selectively and alternately generate the penetrating radiation as described above.

In some examples, the apparatus of the disclosure is configured to determine the flux of the penetrating radiation incident on each detector of a group, based on signal data obtained for each detector element in the group, e.g. by using a method including:
obtaining signal data S_{i′j′} associated with each detector element of the group in the array composed of the plurality of detectors 6, each detector element being located in (i′,j′) at an intersection of a column j′ and a row i′ of the array, i′ corresponding to detector number i′ and j′ corresponding to detector element j′ if the detector is i′, the obtained signal data S for the array of detector elements being such that:

$$S = F ( I , R )$$

with I being a flux assembly corresponding to the flux of the inspection radiation incident on the rows of the array,
   R being a contribution arrangement of coefficients R^{i′j′}ⁱ for the array of detector elements, representing a contribution of a beam of the inspection radiation, incident on row i in the group of detectors, to the signal data S_{i′j′} of the detector element located in (i′,j′) incident on the rows i of the array, and
   F being a known function of I and R; and
determining the flux Iᵢ of the inspection radiation incident on row i, for each row i of the group, based on the obtained signal data S_{i′j′} and the coefficient R_{i′j′}ⁱ for each detector element located in (i′,j′) at the intersection of the column j′ and the row i′ of the array.

In some examples, the method may include normalization of S and/or R.

In some examples, F may be the conditional probability of S given l and R, and determining the flux Iᵢ of the inspection radiation incident on row i, for each row i of the group may include maximizing the probability by maximum likelihood estimation and/or by log-likelihood estimation.

Alternatively or additionally, F may be a linear function such that:

$${S}_{{i}^{′} {j}^{′}} = {\sum }_{i = 1} {R}_{{i}^{′} {j}^{′}}^{i} {I}_{i}$$

with Iᵢ the flux of the inspection radiation incident on row i, and
   R_{i′j′}ⁱ representing a contribution of a beam of the inspection radiation, incident on row i, to the signal data S_{i′j′} of the detector element located in (i′,j′).

In some examples, normalizing the obtained signal data SN, may be such that:

$${S}_{{i}^{′} {j}^{′}}^{N} = \frac{{S}_{{i}^{′} {j}^{′}}^{}}{{S}_{{i}^{′} {j}^{′}}^{0}} = \frac{{S}_{{i}^{′} {j}^{′}}}{{\sum }_{k} {R}_{{i}^{′} {j}^{′}}^{k} , {I}_{k}^{0}} = \frac{{\sum }_{i} {R}_{{i}^{′} {j}^{′}}^{i} {I}_{i}}{{\sum }_{k} {R}_{{i}^{′} {j}^{′}}^{k} {I}_{i}^{0}} = {\sum }_{i} ( \frac{{R}_{{i}^{′} {j}^{′}}^{i} {I}_{i}}{{\sum }_{k} {R}_{{i}^{′} {j}^{′}}^{k}} ) = {\sum }_{i} {C}_{{i}^{′} {j}^{′}}^{i} {I}_{i}$$

with S^{i′j′N} ∈ [0,1],
with S_{i′j′}⁰=Σᵢ R_{i′j′}ⁱIᵢ⁰ with Iᵢ⁰ being the flux of full-scale inspection radiation obtained when no object is placed in the irradiation radiation, incident on row i,
with Iᵢ⁰ being chosen equal to 1 for each row i of the group, which implies the Iᵢ to have values in [0,1],
with each coefficient C_{i′j′}ⁱ, being such that

$${C}_{{i}^{′} {j}^{′}}^{i} = \frac{{R}_{{i}^{′} {j}^{′}}^{i}}{{R}_{{i}^{′} {j}^{′}}^{k}} ,$$

and
with ϵi C_{i′j′}ⁱ=1.

Determining the flux Iᵢ of the inspection radiation incident on row i, for each row i of the group may be based on the normalized uniform signal data S_{i′j′}^{N}, and the coefficient C_{i′j′}ⁱ, for each detector element located in (i′,j′) at the intersection of the column j′ and the row i′ of the array. In some examples, determining the flux Iᵢ of the inspection radiation incident on row i, for each row i of the group may include using a least squares regression to find a set of fluxes Iᵢ which minimizes a criterion Lₛ, such that:

$${L}_{s} = {\sum }_{{i}^{′} , {j}^{′}} {( {S}_{{i}^{′} {j}^{′}}^{N} - {\sum }_{i} {C}_{{i}^{′} {j}^{′}}^{i} {I}_{i} )}^{2} .$$

The set of fluxes Iᵢ which minimizes the criterion Lₛ may be determined using a gradient minimalization technique, or the set of fluxes Iᵢ which minimizes the criterion Lₛ may be determined by determining a solution of a matrix equation Mₖᵢ such that:

$$∀ k , {\sum }_{{i}^{′} , {j}^{′}} {C}_{{i}^{′} {j}^{′}}^{k} {S}_{{i}^{′} {j}^{′}}^{N} = {\sum }_{i} ( {( \underbrace{{\sum }_{{i}^{′} , {j}^{′}} {C}_{{i}^{′} {j}^{′}}^{k} \cdot {C}_{{i}^{′} {j}^{′}}^{i}} )}_{{M}_{ki}} ) \cdot {I}_{i}$$

The calculations of the coefficients C_{i′j′}ⁱ may use properties of the geometry of the apparatus and/or interpolations so that the numbers of calculations may be reduced.

In the embodiment illustrated in FIG. 6B, the fan 4 may include three different zones: the penumbra, the effective direct flux and the lost direct flux. The penumbra comes from oblique rays emitted from out-of-axis parts of the radiation emission zone. The lost direct flux is the part of the radiation which crosses the side opposite the radiation emission zone and which is not detected by detectors. The effective direct flux is detected by the detectors after transmission through the cargo.

As illustrated in FIG. 6B, each source 3 may include a shield 9 configured to shield the detectors, such that the detectors located close to radiation emission zones do not get hit directly by the radiation emitted by the source. Although the shields are illustrated in FIG. 6B only, shields may be provided on other example apparatuses of the other figures.

As illustrated in FIG. 6B, the magnification factor between the shield 9 and the centre of the cargo 2 being more than ten, the lost direct flux can be lower than 20% of the total flux for radiation emission zones smaller than 1 mm in the (OX) direction.

As explained in more detail below, the at least one source includes an electron acceleration device 31, and a Bremsstrahlung target 32 associated with the electron acceleration device 31, for generating the penetrating radiation.

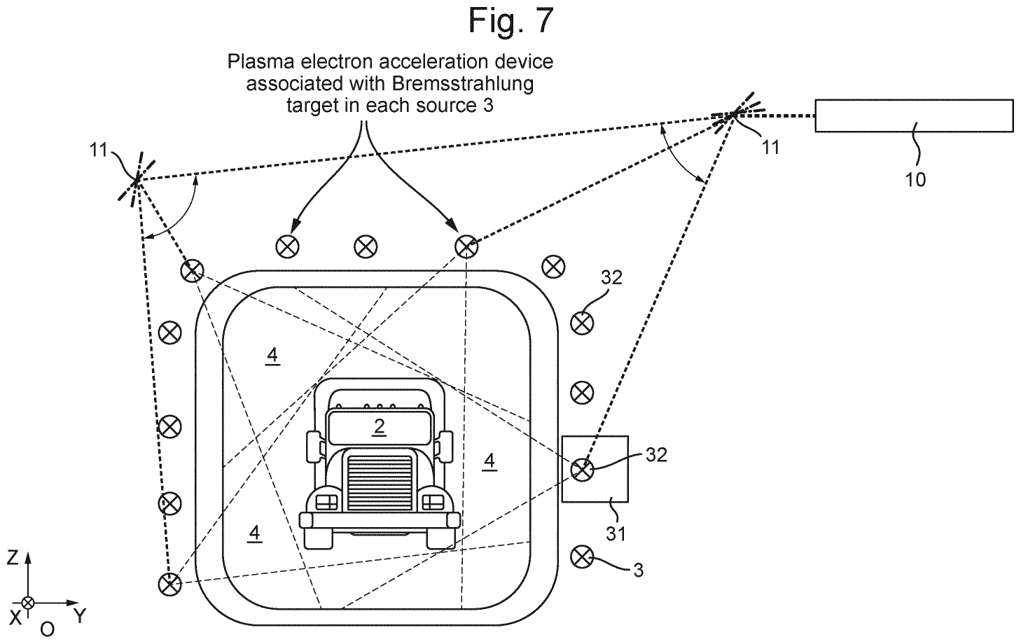

As illustrated in FIG. 7, the electron acceleration device 31 of the at least one source 3 may include a laser-plasma electron acceleration device 31 (only one device is shown in FIG. 7 for clarity, but all the radiation emission zones 3 may be equipped with the device 31). The apparatus may include at least one laser generator 10. The laser generator 10 is configured to generate an ultrafast, ultra-intense laser beam. Each laser-plasma electron acceleration device 31 includes a plasma chamber, configured to receive the laser beam generated by the laser generator 10. The plasma chamber may include a gas and/or a liquid (such as liquid jets) and/or a solid target different from the Bremsstrahlung target. The interaction of the laser beam with the gas or the liquid jets or the solid target of the laser-plasma electron acceleration device 31 spawns a plasma which allows electrons acceleration in the MeV range in a small volume. Such accelerated electrons are projected on the Bremsstrahlung target 32 for insuring generation of the penetrating radiation. In some embodiments, it may be necessary to inject electrons in the plasma created by the interaction of the laser with the gas or the liquid jets or the solid target of the plasma chamber, the plasma being used only for spawning a high electric field for acceleration and, in such embodiments, each laser-plasma electron acceleration device 31 further includes an electron injection device. In other embodiments the plasma is capable of accelerating its own electrons and an electron injection device is not necessary.

In the example of FIG. 7, a single laser generator 10 is associated with the plurality of laser-plasma electron acceleration devices. The laser beam generated by the laser generator 10 is directed to the selected laser-plasma electron acceleration device via at least one mirror 11 configured to rotate. In the example of FIG. 7, the apparatus includes at least two mirrors 11 configured to rotate, to associate the laser generator 10 with the plurality of laser-plasma electron acceleration devices.

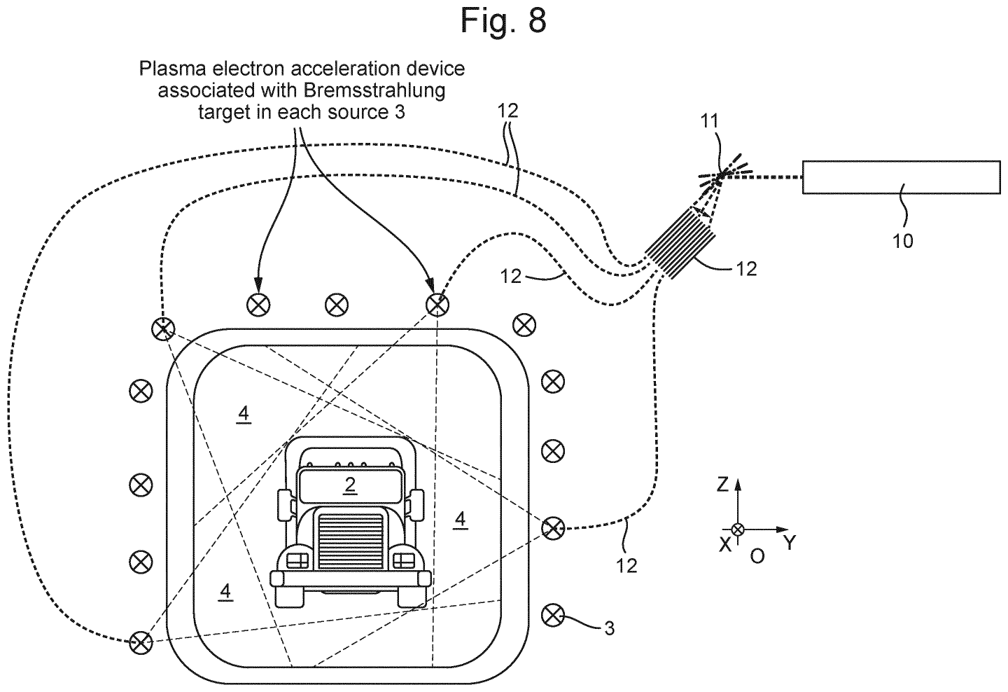

In the example of FIG. 8, the laser generator 10 is associated with the plurality of laser-plasma electron acceleration devices further via a bundle of fiber optics 12.

In the examples of FIGS. 7 and 8, the laser-plasma electron acceleration devices and the Bremsstrahlung targets are static with respect to the cargo in a plane substantially perpendicular to the scan direction (OX).

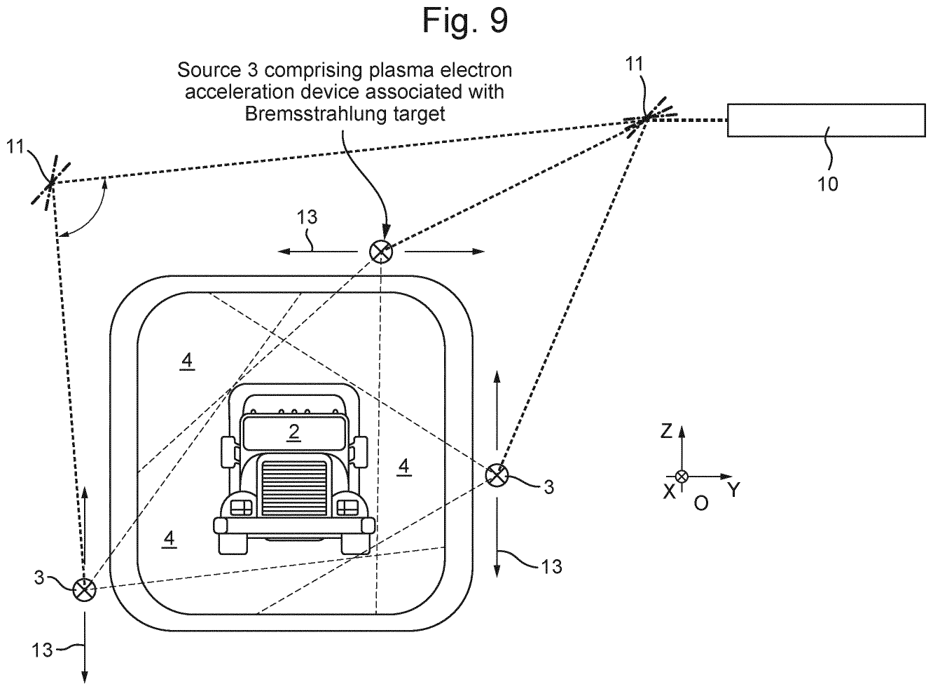

In the example of FIG. 9, the laser-plasma electron acceleration devices and the Bremsstrahlung targets of at least some sources 3 are configured to move with respect to the cargo 2 in a plane substantially perpendicular to the scan direction (OX), as illustrated by the arrows 13. In some examples, all of the laser-plasma electron acceleration devices and the Bremsstrahlung targets may be configured to move. In the example of FIG. 9, two sources 3 are moveable along a direction substantially parallel to the (OZ) direction, on each side of the cargo 2, and one source 3 is moveable along a direction substantially parallel to the (OY) direction. In operation, the combination of the movement of each source 3 with the pulses of the laser generator 10 enables each source 3 to multiply in a multiplicity of radiation emission zones along its movement. For example, each source 3 may generate e.g. ten fans 4 along its movement (other numbers of fans 4 are envisaged). The apparatus of FIG. 9 may thus be equivalent to an apparatus with e.g. 30 radiation emission zones, and therefore with 30 corresponding points of view, in operation.

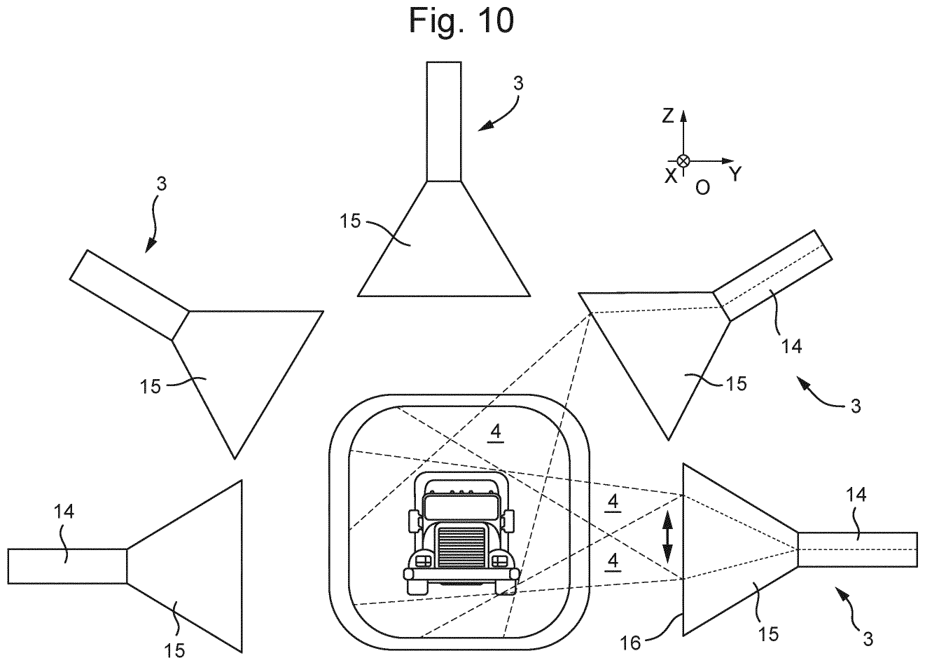

In some examples the electron acceleration device may include a linear accelerator of electrons, In the example of FIG. 10, wherein each source 3 includes a linear accelerator 14 of electrons and a scan horn 15 including a Bremsstrahlung target 16, the scan horn 15 being associated with the linear accelerator 14. Although each scan horn 15 is static in a plane parallel to the (YOZ) plane, each scan horn 15 is configured to direct the beam of electrons from the accelerator 14 at different locations on the target 16, as illustrated by the double arrow. In operation, the different locations of the beam of electrons on the target 16 enable each source 3 to multiply in a multiplicity of radiation emission zones at the different locations of the beam of electrons on the target 16. The apparatus of FIG. 10 includes five sources 3 but, for example, each source 3 may generate e.g. five or ten fans 4 at the different locations of the beam of electrons on the target 16 (other numbers of fans 4 are envisaged). The apparatus of FIG. 10 may thus be equivalent to an apparatus with e.g. 25 or even 50 radiation emission zones and therefore with 25 or 50 corresponding points of view, in operation.

In another example embodiment not illustrated in the figures, at least some of the linear accelerators of electrons and the Bremsstrahlung targets may be configured to move with respect to the cargo in a plane substantially perpendicular to the scan direction, such that no scan horn is necessary.

It should be understood that the apparatus may include a mixture of sources of any aspects of the present disclosure, such as any mixture of movable and static sources, such as some sources including a scan horn and some sources including a moving linear accelerator or a laser-plasma electron acceleration device, as a non-limiting example.

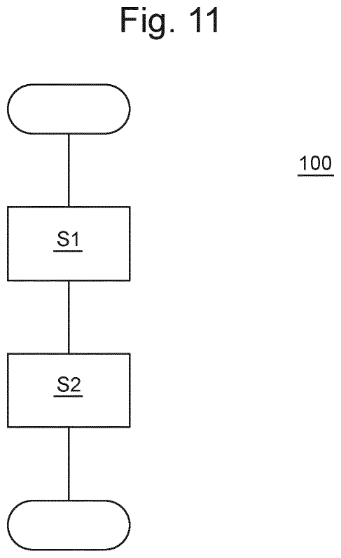

In another aspect of the present disclosure and as illustrated in FIG. 11, it is disclosed a method 100 for inspecting cargo using an apparatus, the cargo and the apparatus having a mutual scan movement substantially along a scan direction during inspection. The method 100 may include:
selectively and alternately generating, at S1, penetrating radiation using a plurality of radiation emission zones configured to at least partially surround the cargo, the plurality of radiation emission zones including at least three radiation emission zones; and
detecting, at S2, the penetrating radiation after transmission through the cargo using a plurality of detectors configured to at least partially surround the cargo.

The method 100 may be performed on the apparatus of any aspects of the present disclosure.

In another aspect of the present disclosure, it is disclosed a computer program or a computer program product including instructions which, when executed by a processor, enable the processor to control the apparatus of any aspects of the present disclosure or to perform the method of any aspects of the present disclosure.

1. An apparatus configured to inspect cargo, the cargo and the apparatus having a mutual scan movement substantially along a scan direction during inspection, comprising:
at least one source configured to generate penetrating radiation, the apparatus being configured to, using the at least one source, generate a plurality of radiation emission zones configured to:
at least partially surround the cargo in a plane substantially perpendicular to the scan direction, and to
selectively and alternately irradiate the cargo,
the plurality of radiation emission zones comprising at least three radiation emission zones; and
a plurality of detectors configured to at least partially surround the cargo in at least one detection plane substantially perpendicular to the scan direction, and to detect the penetrating radiation after transmission through the cargo,
wherein each radiation emission zone in the plurality of radiation emission zones is configured to emit a fan of penetrating radiation towards the cargo in a general direction of emission different from other radiation emission zones in the plurality of radiation emission zones,
wherein each radiation emission zone is associated with a group of the plurality of detectors corresponding to the fan of penetrating radiation emitted by the radiation emission zone,
wherein two respective groups of the plurality of detectors associated with two respective adjacent radiation emission zones selectively and alternately generating penetrating radiation in the plurality of radiation emission zones are configured to share at least two detectors so that the two respective groups partly overlap each other,
wherein the plurality of detectors are static with respect to the cargo in a plane substantially perpendicular to the scan direction, and
wherein the apparatus is configured to output image data for generating one or more images of the cargo based on the penetrating radiation detected by each group of detectors.

2. The apparatus of claim 1, configured to process the image data so that the processed image data contains volumetric information about the cargo.

3. The apparatus of claim 1, wherein the at least one source comprises:
at least one electron acceleration device, and
at least one Bremsstrahlung target associated with the at least one electron acceleration device for generating the penetrating radiation.

4. The apparatus of claim 3, wherein the at least one electron acceleration device comprises a laser-plasma electron acceleration device comprising:
a plasma chamber; and
a gas and/or a liquid and/or a solid target located in the plasma chamber,
the gas and/or the liquid and/or the solid target being configured to cooperate with a laser beam.

5. The apparatus of claim 4, wherein the laser beam for each laser-plasma electron acceleration device is provided by at least one laser generator.

6. The apparatus of claim 5, wherein a single laser generator is associated with a plurality of laser-plasma electron acceleration devices via at least one mirror configured to rotate.

7. The apparatus of claim 5, wherein the at least one laser generator is associated with a plurality of laser-plasma electron acceleration devices further via a bundle of fiber optics.

8. The apparatus of claim 1, wherein the at least one source is configured to be static with respect to the cargo in a plane substantially perpendicular to the scan direction.

9. The apparatus of claim 1, wherein the at least one source is configured to move with respect to the cargo in a plane substantially perpendicular to the scan direction.

10. The apparatus of claim 3, wherein the at least one electron acceleration device comprises a linear accelerator of electrons comprising a scan horn, wherein the scan horn comprises the Bremsstrahlung target for generating at least one radiation emission zone.

11. The apparatus of claim 3, wherein the at least one electron acceleration device comprises a linear accelerator of electrons, wherein the linear accelerator of electrons and the at least one Bremsstrahlung target are configured to move with respect to the cargo in a plane substantially perpendicular to the scan direction.

12. The apparatus of claim 1, wherein each group of the plurality of detectors is configured to be associated with the radiation emission zone configured to emit the corresponding fan of penetrating radiation by absence of readings of detection of penetrating radiation by detectors which are not part of the group, optionally wherein the apparatus further comprises a selector configured to control the readings based on the groups.

13. The apparatus of claim 1, wherein the plurality of radiation emission zones comprises n radiation emission zones, such that:
$$3 < n \leq 1000 [ [ , ] ]$$

14. The apparatus of claim 1, wherein each radiation emission zone Sᵢ in a plurality n of radiation emission zones, such that 1≤i≤n, is configured to emit the fan of penetrating radiation with an angle θi.

15. (canceled)

16. The apparatus of claim 1, wherein the radiation emission zones are located sideways in at least one plane different from the at least one detection plane where the plurality of detectors are located, and
wherein the general direction of emission of each radiation emission zone is tilted with respect to the at least one detection plane, so that the emitted radiation is configured to reach the group of detectors associated with the radiation emission zone.

17. The apparatus of claim 1, wherein the plurality of detectors are located in two detection planes,
wherein the plurality of radiation emission zones are located in a plane located between the two detection planes, and
wherein the general direction of emission of each radiation emission zone is substantially parallel to the two detection planes, so that the emitted radiation is configured to reach the group of detectors associated with each respective radiation emission zone.

18. The apparatus of claim 1, wherein at least some of the plurality of detectors are configured to form a continuous array of detectors all around the cargo in a single plane substantially perpendicular to the scan direction.

19. The apparatus of claim 1, wherein each detector comprises a plurality of stacked detector elements in a plane substantially perpendicular to the scan direction.

20. (canceled)

21. The apparatus of claim 1, wherein the radiation emission zones are configured to selectively and alternately generate the penetrating radiation once and only once during a mutual scan displacement corresponding substantially to a dimension of the plurality of detectors in the scan direction, the selective generation by the radiation emission zones following a selection sequence, optionally wherein the selection sequence comprises at least one of a random sequence, a regular sequence or a successive sequence.

22. (canceled)

23. A method for inspecting cargo using an apparatus, the cargo and the apparatus having a mutual scan movement substantially along a scan direction during inspection, comprising:
selectively and alternately generating penetrating radiation using a plurality of radiation emission zones configured to at least partially surround the cargo, the plurality of radiation emission zones comprising at least three radiation emission zones; and
detecting the penetrating radiation after transmission through the cargo using a plurality of detectors configured to at least partially surround the cargo,
wherein each radiation emission zone in the plurality of radiation emission zones is configured to emit a fan of penetrating radiation towards the cargo in a general direction of emission different from other radiation emission zones in the plurality of radiation emission zones,
wherein each radiation emission zone is associated with a group of the plurality of detectors corresponding to the fan of penetrating radiation emitted by the radiation emission zone,
wherein two respective groups of the plurality of detectors associated with two respective adjacent radiation emission zones selectively and alternately generating penetrating radiation in the plurality of radiation emission zones are configured to share at least two detectors so that the two respective groups partly overlap each other, and
wherein the plurality of detectors are static with respect to the cargo in a plane substantially perpendicular to the scan direction,
the method further comprising outputting image data for generating one or more images of the cargo based on the penetrating radiation detected by each group of detectors.

24. (canceled)

25. (canceled)
